(19) United States
(12) Patent Application Publication
(10) Pub. No.: US 2020/0096067 A1
(43) Pub. Date: Mar. 26, 2020

(54) BRAKE SYSTEM

(71) Applicant: AKEBONO BRAKE INDUSTRY CO., LTD., Tokyo (JP)

(72) Inventors: Brian Lewis Boyle, Farmington Hills, MI (US); Gang Lou, Rochester, MI (US); Michio Suzuki, Wailed Lake, MI (US); Waleed Mahmoud Al-Mahshi, Farmington Hills, MI (US)

(21) Appl. No.: 16/582,045

(22) Filed: Sep. 25, 2019

Related U.S. Application Data
(63) Continuation of application No. 62/736,626, filed on Sep. 26, 2018.

(51) Int. Cl. F16D 65/18; F16D 55/226; F16D 65/097

(52) U.S. Cl. CPC F16D 65/183; F16D 55/226; F16D 2121/24; F16D 2200/0004; F16D 65/0971

(57) ABSTRACT

A brake system that includes a first brake piston; a second brake piston; a first rotary to linear mechanism disposed inside of the first brake piston; a second rotary to linear mechanism disposed inside of the second brake piston; and a motor. The motor is configured to generate torque and supply the generated torque generally equally to both of the first and the second rotary to linear mechanism during a brake apply. A compressible member may be provided between a first member and the first brake piston, a second member and the second brake piston, or both.

### PRIORITY

This application claims the benefit of U.S. 62/736,626 filed on Sep. 26, 2018, the contents of which is incorporated by reference herein for all purposes.

### FIELD

These teachings relate to a brake system.

### BACKGROUND

Some passenger cars and trucks use single-piston hydraulic brake systems for vehicle deceleration. These vehicles may also have a parking brake system that utilizes the same single piston for creating clamping force to maintain the vehicle in a stopped or parked position. In these parking brake systems, a motor may generate sufficient torque to move the single piston, and therefore, the brake pads against the brake rotor to create the clamping brake force.

Other vehicle platforms, like performance vehicles and/or full-size trucks, vans, and SUVs, use multi-piston hydraulic brake systems only for vehicle deceleration, and a separate parking brake system for maintaining the vehicle in a parked position.

To improve parking brake performance, while also reducing weight, costs, complexity, assembly time, and packaging space, in some vehicle platforms, it may be desirable to have a parking brake system that utilizes the existing multi-piston brake system of the service brake.

### SUMMARY

A brake system that includes a brake caliper, and at least one or more brake pistons, but can have three or more brake pistons supported by the brake caliper. One of the brake pistons is configured to move a brake pad during a parking brake apply, and one or more of the brake pistons are configured to move the brake pad during a service brake apply.

A, brake system comprising: a brake caliper, a first inboard brake pad, and a second inboard brake pad. During a service brake apply, the first inboard brake pad is configured to be moved towards a brake rotor. During a parking brake apply, the second inboard brake pad is configured to be moved towards a brake rotor.

A brake system comprising: a brake caliper supporting a first brake piston and a second brake piston, a transferring mechanism, a motor, and a circuit. During a brake apply, the circuit is configured to monitor load on the first brake piston and the second brake piston, and after the load on the first brake piston or the second brake piston reaches a predetermined threshold, or a difference between the load on the first brake piston and the second brake piston reaches a predetermined threshold, the circuit is configured to send a signal to the transferring mechanism to redistribute torque from the motor to one of the first brake pistons and the second brake piston.

A brake system comprising: a brake caliper supporting a first brake piston, the first brake piston comprising a piston pocket comprising a bottom pocket wall, a nut located inside the first brake piston, and a member located between the nut and the bottom pocket wall. During a brake apply, the member is configured to be compressed to reduce an amount of force applied onto the bottom pocket wall by the nut.

A brake system comprising: a brake caliper supporting a first brake piston and a brake pad, and a member located between the brake pad and the first brake piston. During a brake apply, the member is configured to be compressed to reduce an amount of force applied onto the brake pad by the first brake piston.

A brake system comprising: a brake caliper supporting a first brake piston and a second brake piston, a first actuator located inside of the first brake piston, and a second actuator located inside of the second brake piston. The first actuator is reverse threaded relative to the second actuator.

A brake system comprising: a brake caliper, and at least three brake pistons supported by the brake caliper, wherein one of the brake pistons is configured to move a brake pad during a parking brake apply, and two of the brake pistons are configured to move the brake pad during a service brake apply. The brake piston that is configured to move the brake pad during the parking brake apply is located between the two brake pistons that are configured to move the brake piston during the service brake apply. The brake piston that is configured to move the brake pad during the parking brake apply is also configured to move the brake piston during the service brake apply. The brake piston that is configured to move the brake pad during the parking brake apply is located at a leading end of the brake caliper. The brake piston that is configured to move the brake pad during the parking brake apply is located at a trailing end of the brake caliper.

A brake system comprising: a brake caliper, a first inboard brake pad, and a second inboard brake pad. During a service brake apply, the first inboard brake pad is configured to be moved towards a brake rotor. During a parking brake apply, the second inboard brake pad is configured to be moved towards a brake rotor. During the service brake apply, the second inboard brake pad is configured to be moved towards a brake rotor.

A brake system comprising a brake caliper supporting a first brake piston and a second brake piston, a transferring mechanism, a motor, and a circuit. During a brake apply, the circuit is configured to monitor load on the first brake piston and the second brake piston, and after the load on the first brake piston or the second brake piston reaches a predetermined threshold, or a difference between the load on the first brake piston and the second brake piston reaches a predetermined threshold, the circuit is configured to send a signal to the transferring mechanism to redistribute torque from the motor to one of the first brake pistons and the second brake piston.

### BRIEF DESCRIPTION OF THE DRAWINGS

FIG. 1 is a cross-sectional view of a brake system.

FIG. 2 is a cross-sectional view of a brake system.

FIG. 3 is a cross-sectional view of a brake system.

FIG. 4 is a cross-sectional view of a brake system.

FIG. 5 is zoomed-in cross-sectional view of a portion of a brake system.

FIG. 6 is zoomed-in cross-sectional view of a portion of a brake system.

### DETAILED DESCRIPTION

These teachings are directed to a brake system. The brake system may be used with any vehicle and/or machine to slow, stop, or prevent movement of a moving member, such as a wheel, rotor, axle and/or shaft.

The brake system includes a brake caliper. The brake caliper may be a fixed brake caliper with an equal number or unequal number of brake pistons located on each side of the brake rotor. The brake caliper may be a floating brake caliper with one or more brake pistons located on only one side of the brake rotor, and which slides back and forth during a brake apply and release. The brake caliper may be a sliding caliper with pins or slides extending through one or more brake pads or a fixed opposed brake piston. Essentially, the brake caliper may be any brake caliper that has brake pistons that are configured to move a brake pad into contact with a rotor or other surface to generate clamping force to slow, stop, or prevent movement of a moving member, such as a wheel, rotor, axle, and/or shaft.

The brake system disclosed herein can be used to create a clamping force during standard or service braking and/or during parking braking. The brake pistons may be moved by way of pressurized hydraulic fluid and/or with a motor moving one or more rotary to linear mechanisms.

The brake caliper may comprise any number of caliper bores. For example, the brake caliper may comprise one or more caliper bores, two or more caliper bores, three or more caliper bores, four or more caliper bores, five or more caliper bores, six or more, seven or more, nine or more caliper bores, etc. The caliper bores may be located entirely on an inboard side of the brake caliper or brake rotor, entirely on an outboard side of the brake rotor, or located on both the inboard and outboard side of the brake caliper and brake rotor. The caliper bores may be configured to support a brake piston.

The brake system may include one or more motors and/or motor gear units (MGU). The motor or MGU may function to generate torque. The motor or MGU may generate torque and supply the torque to one or more rotary to linear mechanisms, spindles, brake pistons, or a combination thereof. The MGU may include one or more gears that function to increase or decrease a torque output of one or more motors. The motor may be a DC motor. The motor may be a brush motor or a brushless motor. The motor may be a may be a series wound motor, a shunt wound motor, a compound wound motor, a separately exited motor, a servomotor, or a permanent magnet motor.

The motor or MGU may supply or transfer torque directly to a rotary to linear mechanism. For example, the motor or MGU may be directly connected to a spindle or screw of a rotary to linear mechanism. In other configurations, the motor or MGU may be indirectly coupled to a rotary to linear mechanism, for example, by way of a shaft, gear, chain, belt, etc.

The brake system may include one or more rotary to linear mechanisms. The rotary to linear mechanism may be one or more mechanisms that are configured to transfer torque into a linear motion or force. The torque may be supplied by a motor, one or more gears between the motor and the rotary to linear mechanism, or both.

A rotary to linear mechanism may comprise a rotating member and member that is configured to axially move as a result of the rotating member being rotated. For example, the rotary to linear mechanism may include a screw and a nut, a ball nut, ball ramp, a threaded member, or a combination thereof. The rotary to linear mechanism may be a ball screw that includes ball bearings between the spindle or screw and the nut.

During a brake apply, whether for park braking or service braking, the torque may be generated by a motor and then transferred to the spindle, causing the spindle or screw to rotate. Rotation of the spindle may cause a nut to axially move. Axial movement of the nut may apply a pressing force onto the brake piston, which causes the brake piston to move axially out of or relative to the caliper bore that is configured to support the brake piston.

The spindle or screw of the rotary to linear mechanism may be threaded. In brake systems comprising more than one rotary to linear mechanism and thus more than one spindle or screw, the threads on the spindles may be the same throughout. This means, for example, that the spacing of the threads, the pitch, or both may be the same or generally identical for all spindles. Having the same threads (i.e., pitch and spacing) allows for the nuts and thus the brake pistons to be moved at substantially the same time and speed during a brake apply.

In other configurations, it may be desirable to have different threads on the spindles or screws of the rotary to linear mechanisms. Having different threads means that the spacing and/or pitch is different from spindle to spindle in the same brake system. This allows for the spindles to be rotated at generally the same speed via the motor or MGU, but each nut moves at a different speed or distance based on the thread spacing and/or pitch. This may advantageously allow for one brake pad or one end of a brake pad to move at a different speed or rate than another end of a brake pad. This may be advantageous to account for uneven brake pad wear, or taper wear where it is desirable to move one brake pad or one end of the brake pad first or before another end of the brake pad is moved.

The threads on two or more of the spindles or screws may be formed in the same direction. This means that rotating the spindles or screws in the same direction for example in an apply direction, which may be clockwise or counterclockwise, causes the nuts to move along a length of the spindle or screw in an apply direction (i.e., towards a bottom pocket wall of the piston pocket). In other configurations, one or more of the spindles or screws may be reversed threaded. This means that when one spindle or screw is rotated in one direction, the nut moves in an apply direction, but the other spindle or screw must be rotated in the opposite direction for the nut to move in an apply direction.

The brake system includes one or more brake pads. The one or more brake pads may include a friction material and a pressure plate. The friction material may include one or more non-metallic materials, semi-metallic materials, fully metallic materials, and ceramic materials. The friction material may face the rotor so that when the brake pads are moved against the rotor, a friction force is created to slow, stop, and/or restrict movement of a vehicle. The friction material may be slotted or include grooves. The pressure plate may be located opposite the friction surface. One or more brake pistons may be in communication with the pressure plate so that all or an end of a brake pad may be moved towards or away from the rotor. For example, if multiple piston assemblies are located on each side of the rotor, one piston assembly may be moved at a time so that a first end or a second end of the brake pad can contact the rotor before the other end contacts the rotor (i.e., sequential movement).

In some configurations, such as that illustrated in FIG. 2, the brake pad may be two separate brake pads. This may be an inboard brake pad and/or an outboard brake pad. One inboard brake pad may be used to generate a clamping force during a standard and/or parking brake, while another inboard brake may be used to generate a clamping force during a standard and/parking brake. Additionally, or alternatively, one outboard brake pad may be used to generate a clamping force during a standard and/or parking brake, while another outboard brake may be used to generate a clamping force during a standard and/parking brake. The brake pads whether inboard and/or outboard may be provided end to end relative to each other. This means that no space or very small space is defined between the two brake pads. In other configurations, the two brake pads can be spaced apart relative to each other.

In some configurations, there may be three inboard and/or outboard brake pads or brake pad sections that are individually moveable relative to each other depending on the brake piston that is moved during the particular brake apply (i.e., standard braking vs. parking braking).

The brake system may include one or more compressible members. A compressible member may be a member, material, element, or other mechanism that is configured to be compressed, distorted, or otherwise have a changed of shape during a brake apply. The compressible member may function to be compressed during a brake apply and thus reduce an amount of force applied onto the bottom pocket wall of the brake piston by the nut, the rotary to linear mechanism, or both. This may allow for the other nut or rotary to linear mechanism to apply a greater force onto the other brake piston and ultimately onto the brake pad during a brake apply even though the rotary to linear mechanisms are being moved at substantially the same rate and with the same force by the hydraulic fluid and/or the motor. The compressible member may function to be compressed during a brake apply and thus reduce an amount of force applied onto the pressure plate or brake pad by the brake piston. This may allow for the other brake piston to apply a greater force onto the brake pad during a brake apply even though the brake pistons are being moved at substantially the same rate and with the same force by the hydraulic fluid and/or the motor.

A compressible member may be fabricated form a metallic and/or polymeric material. For example, the compressible member may be fabricated from steel, aluminum, brass, copper, spring steel, or another suitable member. For example, the compressible member may be fabricated from rubber, plastic, polypropylene, polyurethane, nylon, or any other suitable polymeric material. The compressible member may be ribbed or have a non-flat cross section. For example, the compressible member may have a U- or C-shaped cross section. The compressible member may have a wavy cross section.

The compressible member may be disposed between a brake piston and a brake pad (or the pressure plate thereof), between a rotary to linear mechanism and a wall of the brake piston, between a nut and a bottom pocket wall of the brake piston, or a combination thereof

The brake system may include more than one compressible member (i.e., two or more compressible members). The two or more compressible members may be fabricated from the same material or a different material. If fabricated from different materials, the compressible member may be selected from materials having the same or different stiffnesses so that the amount of force applied by the brake piston onto the brake pad or onto the brake piston by the nut can be varied. Having different stiffness of compressible members may provide for the brake pistons to be moved at generally the same speed or rate, but apply different pressures or forces on the brake pads, which may result in the different brake pads or ends thereof moving at different speeds or rates or applying different forces onto the brake rotor. This may be advantageous to account for taper wear or uneven brake pads wear.

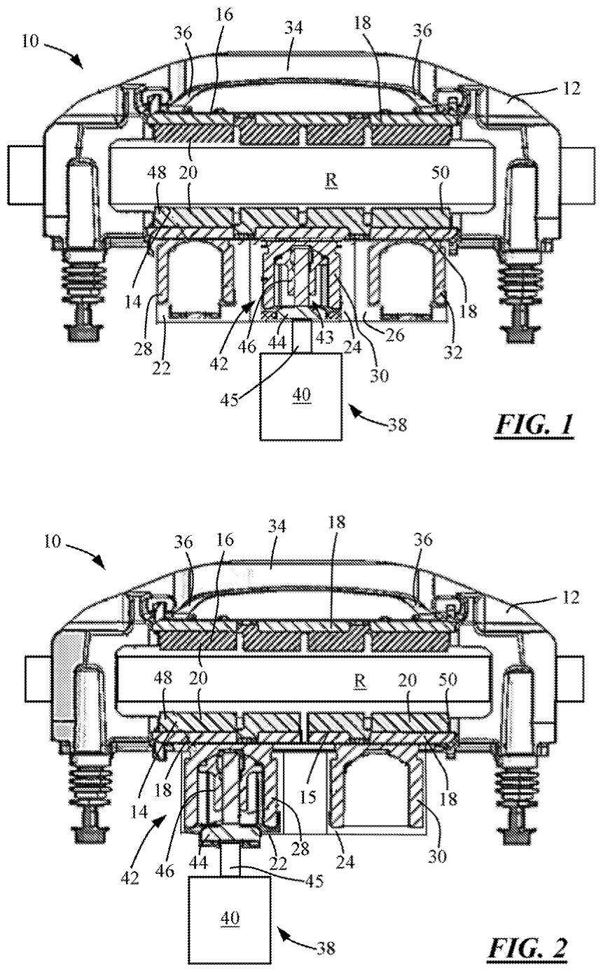

FIG. 1 illustrates a brake system 10. The brake system 10 comprises a brake caliper 12, an inboard brake pad 14, and an opposing outboard brake pad 16. Each brake pad 14, 16 comprises a pressure plate 18 and a friction material 20. The friction material 20 of both brake pads 14, 16 is arranged to face opposing sides of a brake rotor R.

The brake caliper 12 comprises caliper bores 22, 24, 26. Each caliper bore 22, 24, 26 is configured to support a brake piston 28, 30, 32. Each brake piston 28, 30, 32 is configured to face the pressure plate 18 of the inboard brake pad 14. Of course, in some configurations, the brake caliper 12 may include less than three caliper bores, or more than three caliper bores. While the caliper bores are located entirely on the inboard side of the brake rotor R and brake caliper 12, in some configurations some or all of the caliper bores may be located on the outboard side of the brake caliper and brake rotor R.

The brake caliper 12 comprises a bridge 34 and fingers 36. The fingers 36 are configured to contact or engage the pressure plate 18 of the outboard brake pad 16.

The brake system 10 comprises a parking brake system 38. The parking brake system 38 comprises a motor and/or motor gear unit (MGU) 40, which may include one or more gears for increasing or decreasing torque output from the motor. The parking brake system 38 comprises an actuator 42 provided inside brake piston 30. The actuator 42 comprises a rotary to linear mechanism 43. The rotary to linear mechanism 43 may include a spindle 44 and a nut 46. The parking brake system 38 comprises a transferring member 45 that is configured to transfer torque from the motor or MGU 40 to the actuator 42 or, more specifically, to the spindle 44. The transfer mechanism 45 may be an output shaft, an output gear, one or more other gears, or a combination thereof.

During standard braking, or application of the service brake, hydraulic fluid may be pressurized, which causes the leading and trailing brake pistons 28 and 32 to move in an apply direction towards the brake rotor R. Movement of the brake pistons 28, 32 in a direction of the brake rotor R moves the inboard brake pad 14 in a direction of the brake rotor R until the friction material 20 of the inboard brake pad 14 contacts the brake rotor R. Brake piston 30 may or may not be configured to be moved via pressurized fluid during standard braking. During this movement of brake pistons 28, 32 and brake pad 14 against the brake rotor R, an opposite reaction force is generated and the bridge 34 and fingers 36 are configured to pull the outboard brake pad 16 in a direction towards the opposite side of the brake rotor R. Contact between the friction materials 20 of the brake pads 14, 16 and the brake rotor R functions to generate friction or clamping force to slow, stop, or prevent movement of the brake rotor R and thus a road wheel.

During standard braking, or application of the service brake, the motor or MGU 40 is activated to generate torque. The torque can be transferred from the motor or MGU 40 to the actuator 42 via the transferring mechanism 45, which may be one or more gears for example. More specifically, the generated torque is configured to cause the rotary to linear mechanism 43 to generate a linear force in an apply direction. For example, the spindle 44 may rotate in an apply direction, which causes the nut 46 to move the middle brake piston 30 in an apply direction and ultimately the inboard brake pad 14 in a direction of the brake rotor R until the friction material 20 of the inboard brake pad 14 contacts the brake rotor R. During this movement, an opposite reaction force on the bridge 34 causes the fingers 36 to pull the outboard brake pad 16 in a direction towards the brake rotor R. Contact between the friction materials 20 of the brake pads 14, 16 and the brake rotor R is configured to generate friction or clamping force to prevent movement of the brake rotor R and thus a road wheel. The other brake pistons 28, 32, are not configured to move during application and/or release of this brake apply during standard and/or parking braking.

The brake piston 30 may be located or positioned at generally the center of the inboard brake pad 14, generally between the ends 48, 50 of the brake pad 14, and/or generally centered or between the ends of the brake caliper 12. Therefore, during application of the brake using this brake piston 30, the center of the friction material 20 of the brake pad 14 engages the brake rotor R to generate the clamping force.

Alternatively, the brake piston 30 may be located, positioned, or offset towards one end 48, 50 vs another end 48, 50 of the brake pad 14 or brake caliper 12. For example, the brake piston 30 may be located closer to one of the ends 48, 50 that has greater taper wear, or has a tendency to wear out more or faster than the other end 48, 50. Alternatively, the brake piston 30 may be located closer to one of the ends 48, 50 that has less taper wear, or has a tendency to wear out less or slower than the other end 48, 50. This may allow the brake to be set faster or clamping force to be created faster because less movement of the brake pad 14 is required to contact the brake rotor R for example.

The brake piston 30 may be the same size or have the same diameter as one or both of the other brake pistons 28, 32. Alternatively, the brake piston 30 may be bigger or have a larger diameter than one or both of the brake pistons 28, 32. Alternatively, the brake piston 30 may be smaller or have a smaller diameter than one or both of the brake pistons 28, 32.

In some configurations, the actuator 42 may instead be located inside brake piston 28 and/or brake piston 32, and be used in the same manner described above to move the corresponding brake piston 28, 32 to generate a clamping force during standard braking and/or during parking braking.

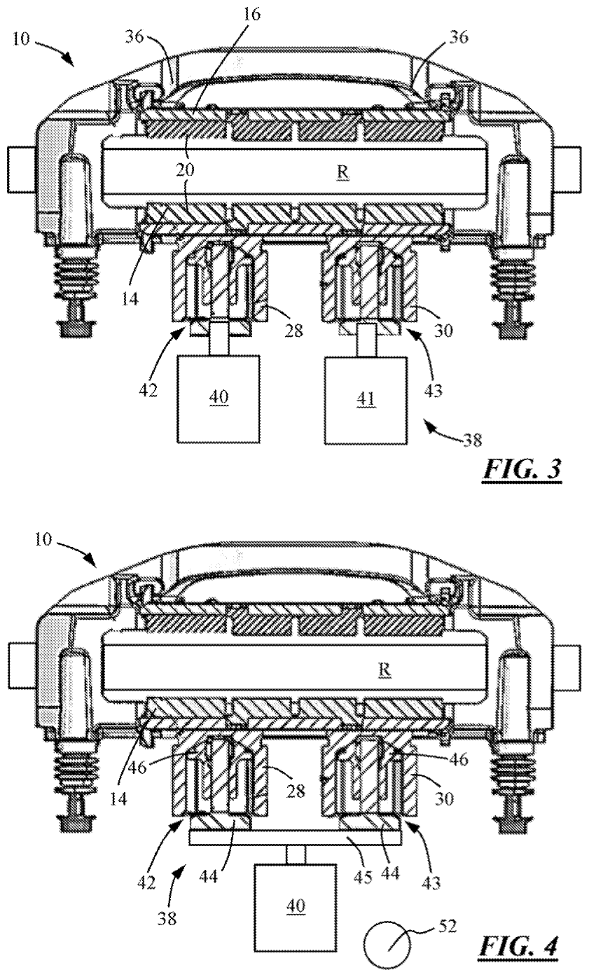

In some configurations, the parking brake system 38 may comprise an actuator 42 (spindle 44 and nut 46) located inside brake piston 28 and/or brake piston 32 connected to the MGU or motor 40 or to a discrete or separate MGU or motor 40 (i.e., like FIG. 3).

The brake piston 30 or the face thereof that faces the inner brake pad 14 may be connected or fixed to the pressure plate 18 of the inner brake pad 14 so that the position of the brake piston 30 relative to the caliper bore 24 changes during application of the brake system (i.e., during movement of the inboard brake pad 14 during standard and/or parking braking). This may be advantageous to ensure the position of the brake piston 30 stays generally the same over time as the brake pad 14 wears over time. The actuator 42, or more specifically, the nut 46, may move with the brake piston 30 so that a position of the nut 46 relative to the brake piston stays generally the same. This may be accomplished with a nut 46 that is part of a ball nut assembly, for example. Such an actuator is disclosed in Applicant's previously-filed patent application Ser. No. 15/434,407; filed on Feb. 16, 2017, which is incorporated by reference herein.

FIG. 2 illustrates a brake system 10. The brake system 10 comprises a brake caliper 12, a first inboard brake pad 14, a second inboard brake pad 15, and an outboard brake pad 16 opposing both inboard brake pads 14, 15. Each brake pad 14, 15, 16 comprises a pressure plate 18 and a friction material 20. The friction material 20 of the brake pads 14, 15 and 16 are arranged to face opposing sides of a brake rotor R. The inboard brake pads 14, 15 are separate components that can be moved independently of each other, depending on the brake piston 28 that is moved during a brake apply.

The brake caliper 12 comprises caliper bores 22, 24. Each caliper bore 22, 24 is configured to support a brake piston 28, 30. Each brake piston 28, 30 is configured to face the pressure plate 18 of a corresponding one of the inboard brake pads 14, 15.

The brake caliper 12 comprises a bridge 34 and fingers 36. The fingers 36 are configured to contact or engage the pressure plate 18 of the outboard brake pad 16.

The brake system 10 comprises a parking brake system 38. The parking brake system 38 comprises a motor or motor gear unit (MGU) 40. The parking brake system 38 comprises an actuator 42 provided inside brake piston 28. The actuator 42 may be a rotary to linear mechanism that is configured to translate or transfer torque into a linear force. For example, the rotary to linear mechanism may be a ball screw, a ball ramp, a screw, a nut, a ball nut, etc. The rotary to linear mechanism may include a spindle 44 and a nut 46. In some configurations, brake piston 30 may comprise the actuator 42 and brake piston 28 may, or may not, comprise an actuator. The parking brake system comprises a transferring member 45 that is configured to transfer torque from the motor or MGU to the actuator 42.

During standard braking, or application of the service brake, hydraulic fluid is pressurized, which causes the brake piston 28 and 30 to move, and movement of the pistons 28, 30 causers both of the corresponding inboard brake pads 14, 15 to move in a direction of the brake rotor R until the friction material 20 of the inboard brake pads 14, 15 contacts the brake rotor R. An opposite reaction force on the bridge causes the fingers 36 to pull the outboard brake pad 16 in a direction towards the brake rotor R. Contact between the friction materials 20 of the brake pads 14, 15, 16 and the brake rotor R is configured to generate friction or clamping force to slow, stop, or prevent movement of the brake rotor R and thus a road wheel.

During standard braking, or application of the service brake, the motor or MGU 40 can be activated or turned ON to generate torque. The torque can be transferred from the motor or MGU 40 to the actuator 42 via the transferring mechanism 45. More specifically, the generated torque is configured to cause the spindle 44 to rotate, which causes the nut 46 to move the brake piston 28 and ultimately the first inboard brake pad 14 in a direction of the brake rotor R so that the friction material 20 of the first inboard brake pad 14 contacts the brake rotor R. During this movement, the second inboard brake pad 15 is not moved. During movement of the brake piston 28 and the first inboard brake pad 14, an opposite reaction force on the bridge causes the fingers 36 to pull the outboard brake pad 16 in a direction towards the brake rotor R. Contact between the friction materials 20 of the brake pads 14, 16 and the brake rotor R is configured to generate friction or clamping force to prevent movement of the brake rotor R and thus a road wheel.

FIG. 3 illustrates a brake system 10 that may comprise one or more of the features described herein; therefore, in the interest of brevity, like features will not be described again. The parking brake system comprises motor or MGU 40 in communication with actuator 42, which comprises a spindle and nut inside brake piston 28. The parking brake system comprises motor or MGU 41 in communication with actuator 43, which comprises a spindle and nut inside brake piston 30.

During standard braking, or application of the service brake, hydraulic fluid is pressurized, which causes brake pistons 28 and 30 to move the inboard brake pad 14 in a direction of the brake rotor R so that the friction material 20 of the inboard brake pad 14 contacts the brake rotor R. An opposite reaction force on the bridge causes the fingers 36 to pull the outboard brake pad 16 in a direction towards the brake rotor R. Contact between the friction materials 20 of the brake pads 14, 16 and the brake rotor R is configured to generate friction or clamping force to slow, stop, or prevent movement of the brake rotor R and thus a road wheel.

During application of the parking brake, one or both of the motors or MGUs 40, 41 can be activated to generate torque. The torque can be transferred from one or both of the motors or MGUs 40, 41 to one or both of the actuators 42, 43, which each comprise a spindle and nut like those illustrated and described above at FIG. 1. More specifically, the generated torque is configured to cause the corresponding spindles to rotate, which causes the corresponding nuts to move the corresponding brake piston 28, 30 and ultimately the inboard brake pad 14 in a direction of the brake rotor R so that the friction material 20 of the first inboard brake pad 14 contacts the brake rotor R. During movement of one or both of the brake pistons 28, 30 an opposite reaction force on the bridge causes the fingers 36 to pull the outboard brake pad 16 in a direction towards the brake rotor R. Contact between the friction materials 20 of the brake pads 14, 16 and the brake rotor R is configured to generate friction or clamping force to prevent movement of the brake rotor R and thus a road wheel. One or both of the brake pistons 28, 30 are moved until a sufficient clamping force is created.

FIG. 4 illustrates a brake system 10 that may be substantially similar to the one illustrated at FIG. 3, except the brake system 10 of FIG. 4 includes a single motor or MGU 40 in communication with both of the actuators or rotary to linear mechanism 42, 43 via the transferring member 45 that is configured to transfer a substantially equal amount of torque from the motor or MGU 40 to both of the spindles of the actuators 42, 43. Thus, during a brake apply or a parking brake apply, a substantially equal torque from the motor or MGU 40 is transferred to both actuators 42, 43, which causes both pistons 28, 30 to move the inboard brake pad 14 in a direction of the brake rotor R until a sufficient clamping force is created.

With continued reference to FIG. 4, in some configurations, the thread spacing in one of the actuators 42, 43 may be different than the thread spacing in the other actuator 42, 43. More specifically, the thread spacing between spindle 44 and nut 46 of actuator 42 may be different than the thread spacing between spindle 44 and nut 46 of actuator 43. This means that during application of the brake, the torque generated by the motor or MGU 40 may still be equally distributed to both actuators 42, 43; however, because the thread spacing is different between the two actuators 42, 43, the nut 46 on one of the actuators 42, 43 may move faster in an apply direction than the other nut 46 on the other actuator 42, 43. This may be advantageous in compensating for any taper wear that may occur on the inboard brake pad 14 in order to move or push the end of the brake pad 14 more or faster that is worn out more than the other end.

With continued reference to FIG. 4, in some configurations, one of the brake pistons 28, 30 may telescope outwardly during movement in an apply direction towards the brake piston 14. During application of the parking brake for example, the torque generated by the motor or MGU 40 may be equally distributed to both actuators 42, 43; however, because one of the brake pistons 28, 30 is configured to telescope during movement in the apply direction, that brake piston 28, 30 may move faster in an apply direction than the brake piston 28, 30. This may be advantageous in compensating for any taper wear that may occur on the inboard brake pad 14 in order to move or push the end of the brake pad 14 more or faster that is worn out more than the other end.

With continued reference to FIG. 4, in some configurations, the brake system 10 and/or the parking brake system 38 may comprise a circuit 52 that is configured to monitor actuators 42, 43, brake pistons 28, 30, and/or the transferring member 45 that is configured to transfer torque from the motor or MGU 40 to the actuators 42, 43. When the load or force acting on one of the brake pistons 28, 30 is higher than a load or force acting on the other brake pistons 28, 30, the circuit 52 may be configured to send a signal to the transferring member 45 to re-distribute torque supply from the motor or MGU 40 to the other actuator 42, 43 to move the other brake piston 28, 30 with the lower load or force acting on it. The other actuator 42, 43 with the higher load or force acting on the corresponding brake piston 28, 30 may cease moving or move slower, while the actuator 42, 43 associated with the lower load or force acting on the corresponding brake piston 28, 30 may move faster or continue moving.

With continued refence to FIG. 4, in some configurations, the actuators 42, 43 may be ball screws that are connected together, however, one of the actuators 42, 43 may be reverse threaded. This means that for the nuts 46 to move in an apply direction during a brake apply or parking brake apply, one of the spindles 44 must be rotated in a clockwise direction, while the other spindle 44 must be rotated in a counter clockwise direction. The transferring mechanism 45 may function to reverse the torque output from the motor or MGU 40 to the spindle 44 that is reverse threaded with two meshing gears, for example. By having such an arrangement of interconnected, oppositely-threaded spindles 44, when the load or force acting on one of the brake pistons 28, 30 is higher than a load or force acting on the other brake pistons 28, 30, the actuator 42, 43 with the higher-loaded brake piston 28, 30 will begin to spin in the opposite direction (i.e., the same direction that the other actuator 42, 43 is configured to rotate), which will function to cause the lower-loaded brake piston 28, 30 to continue to move or move faster than the other actuator and/or brake piston 28, 30.

With continued refence to FIG. 4, in some configurations, the brake system 10 or parking brake system 38 may comprise a clutch located between one or both of the spindles 44 and the transferring mechanism 45. The clutch may be configured to spin or slip after the load or force acting on one of the brake pistons 28, 30 is higher than a load or force acting on the other brake pistons 28, 30. With the clutch slipping or preventing or reducing the amount of torque from the motor or MGU 40 being transmitted to that spindle 44, that actuator 42, 43 with the higher-loaded brake piston 28, 30 will slow or cease moving while the other actuator 42, 43 will continue to move the corresponding brake piston and thus corresponding end of the brake pad 14 against the brake rotor R to generate clamping force.

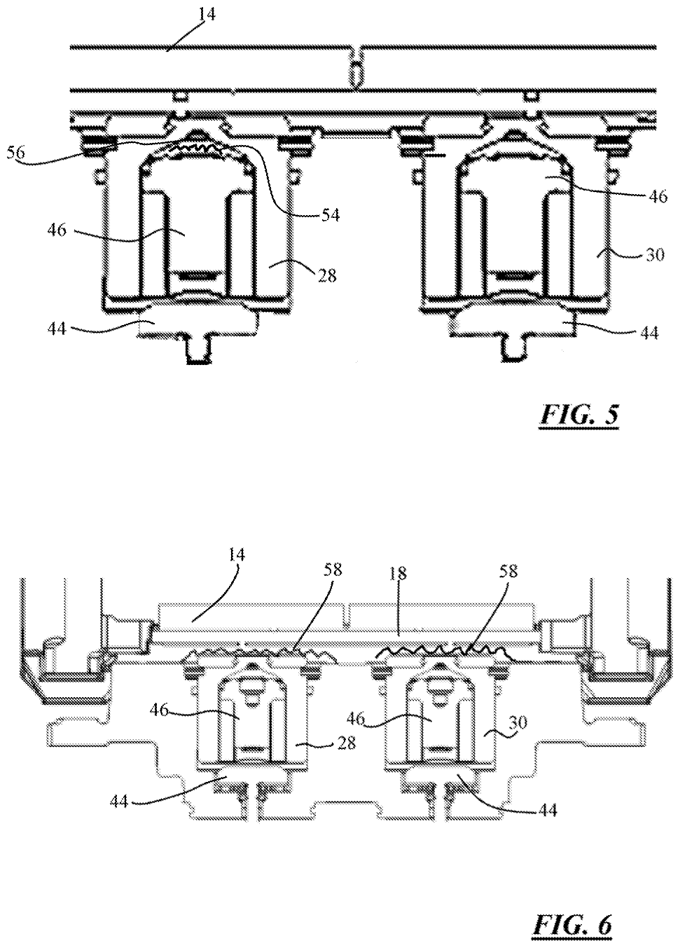

Referring to FIG. 5, the brake system 10 may comprise a member 54 located between nut 46 and the bottom pocket wall 56 of the brake piston 28. During a brake apply or parking brake apply, the motor or MGU 40 is configured to apply equal torque to both actuators or spindles 44 so that both nuts 46 move the inboard brake pad 14 against the brake rotor to create the clamping force. If the load or force acting on one of the brake pistons 28, 30 is higher than the load or torque acting on another one of the brake pistons 28, 30, the force by that nut 46 onto the bottom pocket wall 56 of the brake piston 28 may increase, which may function to cause the member 54 to collapse or crush, thus reducing the amount of force applied by the nut 46 onto the brake piston 28, and thus reduce the movement or force applied by that end of the brake pad 14 against the brake rotor. The member 56 may be a spring, a Belleville washer, a soft or complaint member, a rubber or other polymeric member, a member made of metal or spring steel, or a combination thereof. The member 56 may be comprised of a material or assembly that increases in force or resistance the more the member 56 is crushed or compressed. Having such a member may be advantageous to prevent the brake pad 14 from twisting or cocking during a parking brake apply, which may occur if one end of the brake pad 14 is tapered or worn more than an opposite end of the brake pad 14. The member 56 may be provided in one or both or more brake pistons 28, 30. The member 56 may be provide in the brake piston 28, 30 associated with the end of the brake pad 14 that typically sees less wear compared to the other brake piston 28, 30.

In another configuration, a member like member may be provided between nut 46 and the bottom pocket wall of the brake piston 30. The member in brake piston 30 may be the same as member 56 in brake piston 28. Alternatively, the member in brake piston 30 may be stiffer or less stiff than the member 56 in brake piston 28.

Referring to FIG. 6, the brake system 10 may comprise a member 58 located between one or both of the brake pistons 28, 30 and the pressure plate 18 of the inboard brake pad 14 (and/or pad 15 in the case of FIG. 2). During a brake apply or a parking brake apply, the pistons 28, 30 are configured to move the inboard brake pad 14 against the brake rotor to create the clamping force. If the load or force acting on one of the brake pistons 28, 30, is higher than the load or torque acting on another one of the brake pistons 28, 30, the force applied onto that corresponding end of the brake pad 14 may increase, which may cause the member 58 to crush or flex, while may function to reduce the amount of force applied onto that end of the brake pad 14 by that brake piston 28, 30. Accordingly, the other end of the brake pad 14 may be moved against the brake rotor R to generate the clamping force. The member may be a spring, a Belleville washer, a soft or complaint member, or a combination thereof. The member may be comprised of a material or assembly that increases in force or resistance the more the member is crushed or compressed. This may be advantageous to prevent the brake pad 14 from twisting or cocking during a parking brake apply, which may occur if one end of the brake pad 14 is tapered or worn more than an opposite end of the brake pad 14. The member 56 may be provided in the brake piston 28, 30 associated with the end of the brake pad 14 that typically sees less wear.

Referring to any of the brake systems disclosed herein, the friction material 18 of the inboard brake pad 14 may have a higher coefficient of friction than the friction material 18 of the outboard brake pad 16. For example, the coefficient of friction of the friction material 18 of the inboard brake pad 14 may be 1× higher than the coefficient of friction of the friction material 18 of the outboard brake pad 16. For example, the coefficient of friction of the friction material 18 of the inboard brake pad 14 may be 1.1× or more higher, 1.5× or more higher, 2× higher, 3× higher, etc., than the coefficient of friction of the friction material 18 of the outboard brake pad 16.

It is understood that one or more of the features or elements illustrated in the appended figures and/or described in the above paragraphs may be combined with one or more features or elements illustrated in other figures and/or described in other paragraphs. That is, for example, elements in FIG. 1 are not necessarily limited to only the system illustrated and described in FIG, 1; instead, the features or elements may be combined with the system in FIG. 5 and vice versa. Moreover, some elements illustrated and/or described may be optional, omitted or eliminated, duplicated, replaced, and/or reduced in number and still be within the scope of this disclosure.

Moreover, while the disclosure referrers to operation during a standard brake apply or service brake apply and a parking brake apply, it is understood that those terms can be used interchangeably. For example, while the MGU 40 and actuator 42 in FIG. 1 is described as being used during a parking brake apply, it is within the scope of this disclosure that the MGU 40 and actuator 42 in FIG. 1 can also be use, or can be used instead to create a clamping force during standard braking or service brake application. Moreover, while brake pistons 28 and 32 are described in FIG. 1 as being used only during standard braking or service brake application, it is understood those pistons can be used to create clamping force during parking brake application. The same applies to the systems illustrated and described in the other figures.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

1) A brake system comprising:
a first brake piston;
a second brake piston;
a first rotary to linear mechanism inside of the first brake piston;
a second rotary to linear mechanism inside of the second brake piston; and
a motor;
wherein during a brake apply, the motor is configured to generate torque and supply the generated torque generally equally to both of the first and the second rotary to linear mechanism.

2) The brake system according to claim 1, wherein the first rotary to linear mechanism comprises a first threaded member, and the second rotary to linear mechanism comprises a second threaded member, and the first threaded member is reversed compared to the second threaded member.

3) The brake system according to claim 1, wherein during the brake apply, the first brake piston and the second brake piston are moved at different speeds.

4) The brake system according to claim 2, wherein during the brake apply, the first brake piston and the second brake piston are moved at different speeds.

5) The brake system according to claim 1, wherein the brake system comprises a compressible member disposed between the first rotary to linear mechanism and a bottom pocket wall of the first brake piston.

6) The brake system according to claim 5, wherein the compressible member is a metallic material.

7) The brake system according to claim 5, wherein the compressible member is a polymeric material.

8) The brake system according to claim 4, wherein the brake system comprises a compressible member disposed between the first rotary to linear mechanism and a bottom pocket wall of the first brake piston.

9) The brake system according to claim 8, during the brake apply the compressible member is compressed between the bottom pocket wall of the first brake piston and the first rotary to linear member.

10) The brake system according to claim 9, wherein the brake system comprises a second compressible member disposed between the second rotary to linear mechanism and a bottom pocket wall of the second brake piston.

11) The brake system according to claim 1, wherein the brake system comprises a compressible member disposed between the first brake piston and a brake pad.

12) The brake system according to claim 10, wherein a material of the compressible member is different than a material of the second compressible member.

13) A brake system comprising:
a first brake piston;
a second brake piston;
a first rotary to linear mechanism disposed inside of the first brake piston, the first rotary to linear mechanism comprising a nut disposed in a piston pocket of the first brake piston;
a first compressible member disposed in the piston pocket of the brake piston;
a second rotary to linear mechanism disposed inside of the second brake piston;
a motor;
wherein the motor is configured to generate torque and supply the generated torque to both of the first and the second rotary to linear mechanism during a brake apply, and during the brake apply the first compressible member is compressed between the nut and a bottom wall of the piston pocket.

14) The brake system according to claim 13, wherein the first compressible member is a metallic material.

15) The brake system according to claim 13, wherein the first compressible member is a polymeric material.

16) The brake system according to claim 13, wherein during the brake apply, the first brake piston and the second brake piston are moved at different speeds.

17) The brake system according to claim 16, wherein the first rotary to linear mechanism comprises a first threaded member, and the second rotary to linear mechanism comprises a second threaded member, and the first threaded member is reversed compared to the second threaded member.

18) The brake system according to claim 16, wherein the first rotary to linear mechanism comprises a first threaded member, and the second rotary to linear mechanism comprises a second threaded member, and spacing of threads on the first threaded member is different than a spacing of threads on the second threaded member.

19) The brake system according to claim 13, wherein the brake system comprises a second compressible member,
wherein the second rotary to linear mechanism comprises a second nut disposed in a piston pocket of the second brake piston; and
wherein a stiffness of the second compressible member is different than a stiffness of the first compressible member.

20) The brake system according to claim 19, wherein a material of the first compressible member is different than a material of the second compressible member.
